(19) United States
(12) Patent Application Publication
(10) Pub. No.: US 2017/0156458 A1
(43) Pub. Date: Jun. 8, 2017

(54) Rocking Stick, Walking, Fitness and Rehabilitation System

(71) Applicant: Sarah Hayden, Newburyport, MA (US)

(72) Inventor: Sarah Hayden, Newburyport, MA (US)

(21) Appl. No.: 14/956,895

(22) Filed: Dec. 2, 2015

(51) Int. Cl. A45B 9/04; A61H 3/02; A45B 9/02

(52) U.S. Cl. CPC A45B 9/04; A45B 9/02; A61H 3/0277; A45B 2009/005

(57) ABSTRACT

A support, exercise and rehabilitation apparatus designed to facilitate walking with a normal gait to promote a natural, upright walking motion. The apparatus includes two main portions, a handle assembly comprising a shaft, and a rotational or rocker base. The shaft adjusts to various heights and locks securely with a polymer, metal or composite lock-nut silencer. The rocker base contains a non-slip tread and a wide base to absorbs more weight and shock and disperses both over a wider area and thus moves with the user as the user moves forward, offering greater support.

### CROSS REFERENCE TO RELATED APPLICATION

This application takes priority from and claims the benefit of U.S. Provisional Patent Application No. 62/086,422 filed on Dec. 2, 2014, the contents of which are herein incorporated by reference.

### FIELD OF THE INVENTION

The present invention relates generally to walking, fitness and rehabilitation system utilized and specifically to a system, which in use rehabilitates while provided the user a superior means of recovery and movement.

### BACKGROUND OF THE INVENTION

Concurrently many ambulatory, stretching, exercise and rehabilitation aid systems exist including: walking canes, walking sticks, crutches, walkers, etc., which are designed to provide stability to persons requiring assistance when walking or standing. Base of support is the area within an outline of all ground contact points and increasing the size of the base of support immediately increases stability when stationary. Stability is achieved as a result of the additional point of ground contact which increases their base of support.

However, locomotion is a complex task involving many individual motions in three planes of space and a base of support is just one of the many factors in bipedalism. Instability may be caused by dysfunction of one or more areas of the body that are responsible for balance and movement. Normal gait, or locomotion, is a mechanism which depends on the closely integrated action of the musculoskeletal system on three different planes (frontal, sagittal, transverse), peripheral and central nervous system, visual, vestibular, auditory, and sensory-motor systems. The degree of integration will determine whether gait patterns are normal or pathological. Normal gait patterns require the ability to maintain upright posture and balance; initiate and maintain rhythmic stepping; maintain torso rotation and contralateral are swing; adequate muscular strength and joint range of motion; and intact visual, vestibular, auditory, and sensory-motor input.

Six determinants of the gait cycle deal with the conservation of energy during normal human locomotion. These are the elements of human lower extremity function that account for a smooth sinusoidal path thus maintaining the body's center of gravity (CG) within a 2″ horizontal and vertical displacement. The combination of the six motion patterns (horizontal and vertical) decreases the displacement of the CG of the body by approximately 50%. Thus conserving energy and continuing forward momentum.

The six determinants of the gait cycle are as follows:

### 1. Pelvic Rotation;

### 2. Pelvic Tilt;

3. Knee Flexion in midstance;
4. Foot and Ankle motion;
5. Knee motion; and,
6. Lateral Pelvic motion.

Thus, in evaluating issues which influence the gait cycle through aging or injury, the Spinal Engine Theory and the transformation of energy in the gravitational field via the viscoelastic properties of the fascia, must be recognized to properly realize that those lower body determinants are the precise body kinematics (angular movements (degrees of motion for pelvis, knees, feet) and kinetics (what causes the body to move—momentum, inertia, mass, force etc.) to be the most energy efficient in the gravitational field.

Further, the addition to the equation of the upper body determinants, which were inconsistently considered or addressed as many theories assumed that the legs were responsible for the all the forward motion—when actually the motion is more akin to bouncing up and down or even winding and unwinding.

Thus, as discussed herein, there exist multiple mechanical and biomechanical forces acting on the body during locomotion such as muscles, ligaments, tendons, fascia, gravity, momentum, friction, tension, compression and ground force reaction. The walking aid or cane must function as a compensatory tool for system integration deficiencies and the associated forces.

Generally, conventional walking aids and canes with a fixed design or with a spring mechanism design as part of the foot piece or tip(s) require downward push by arm and torso to create frictional resistance between cane tip(s) and ground or floor to provide support during use even devices with multiple tips, that may vary in such parameters as how many tips are in contact with the ground and canes with foot-shaped footpieces, because they are used to shift weight up and over the relatively fixed cane. Canes and walking aids that are available today rely on the depression of the shoulder, or scapula, to achieve the downward push for effective use.

To date, design and function of these devices has been based on dated linear models of mechanics to solve the problem of how to unload compressive forces acting upon a body in motion. Newton's laws of motion have been well established as the basis for understanding biomechanics viewing bones, muscles, and connective tissues as separate entities producing movement by the action of the muscles on skeletal levers. Linear models of mechanics have also been the basis for understanding human locomotion. In most models of gait, pelvic rotation is basic to walking and the pelvic motion is said to be driven from the legs with the upper extremities as passengers.

The function of devices used to aid in walking has been to unload the compressive forces on the lower extremities created by superincumbent body weight and vertical ground reaction force. From a biomechanical standpoint based on the linear models discussed above, load on joints can be decreased by shifting the mechanical axis and/or by sharing body weight with a device. This unloading of force is accomplished by depressing the shoulder and pushing downward on the device with the arm creating a fixed contact point to redirect compressive forces to the ground. The depression of the shoulder has several associated problems such as slippage of device due to decrease in frictional contact and discomfort in upper extremities and torso due to the degree of downward push that may be required. Walking aids currently available today have aimed at resolving those problems.

Normally, the user is moving past a fixed point between the cane and the ground. This theoretical perspective holds that the lower extremities are the primary tools by which humans ambulate and thus the trunk, head, and upper extremities are considered “passengers” and the goal of gait is to transport the passenger unit on the locomotor unit—lower limbs and pelvis. The degree of downward push or force will vary depending upon the type of system deficiency and the corresponding impact of gait forces.

If a cane is used for stability but is not needed for unloading body weight it may be held in either hand with less downward push or force. A cane used for joint load reduction has been shown to be more effective when held in the contralateral hand opposite affected limb. Users are instructed to hold handle with the weight to the rear of center. Traditional theory of human movement is based on the lever system. Bones, ligaments, and muscles are the structures that form levers in the body to create movement. Joints form the axis or fulcrum and the muscles crossing the joint apply the force to move a weight or resistance. Based on this theory, placing the cane in the contralateral hand extends the moment arm and reduces hip forces in ipsilateral hip.

In classical theories of human ambulation, normal gait involves pelvic adjustments that are said to minimize movement of the center of gravity and thereby conserve energy. To control excessive pelvic tilt beyond the normal limits (4 degrees anteriorly and 4 degrees posteriorly for normal slow walk), the hip abductors on single stance limb will stabilize the pelvis with an equal and opposite force. Assistance with hip abductors can be helpful if their strong compressive forces across the hip joint cause pain or if they are weak in general and cannot function effectively and support the pelvis while in unilateral stance. Walking aids and canes provide support by acting like a substitute for the hip abductors on the stance leg by creating an additional force that keeps the ipsilateral pelvis neutral during unilateral stance.

This additional force is created by the depression of the scapula and the activation of several upper body muscles on the ipsilateral side including pectoralis minor, lower fibers of the trapezius, subclavius, and lower fibers of the latissimus dorsi. The latissimus dorsi attaches to the posterior side of the iliac crest on pelvis. The force of downward push on the cane arrives on the pelvis through a contraction of the latissimus dorsi. This contraction results in an upward pull on the iliac crest of pelvis on the ipsilateral side in swing phase, supporting the pelvis and substituting for the function of the hip abductors.

Adequate strength is required in the muscles of the wrist, elbows, shoulder girdle, and trunk for effective transfer of the cane's vertical reaction force to the top of the pelvis. A portion of the load will also pass through arm to the cane and finally to ground.

Whether the walking aid or cane is used for balance and/or reduction of load from body weight and gravity, Newtonian theory holds that the downward push on the cane will be met with an equal upward ground force reaction which results in an increase in the body's vertical excursion in the frontal plane. This upward movement is caused because the user must push against the ground to create enough friction to hold the cane in place.

The back muscles are activated by the downward push in preparation for transference of weight, the muscles along the spine shorten with a concentric contraction, and the lower back moves to a neutral position as the pelvis or innominate is supported. Using the normal cane to support the pelvis prevents the pelvis from dropping excessively while the leg is in swing phase but in doing so causes substantial interference with natural movements of both pelvis and shoulder girdle.

During a normal gait cycle when the leg is in swing phase the pelvis of the swing leg would be tilting 5 degrees below the horizontal and rotating anteriorly 4 degrees. The entire body would be lower, and at the lowest point during double stance. The body position when there is downward push on a cane prevents the pelvis from reaching the normal maximum tilt and rotation. Since the shoulder motion and the hip motion are restricted, the hip cannot fully extend the swing leg out in front, lowering the body as it approaches the double stance phase.

Thus, this renders the body higher (more upright) than normal because in order to exert downward force or push on a cane to create the friction to hold the cane foot in place, the standing leg needs to have the knee in extension (straightened) so the quadriceps can provide the support as the upper body pushes down on the cane.

Due to the pelvic restriction and the inability for the body to drop down naturally as it approaches the double stance phase, the step length shortens and as the foot makes contact with the floor the foot is almost flat on the bottom rather than heel touching first because there is minimal angle of the leg as it comes down to touch the floor.

The foot is parallel to floor, rather than landing with the heel first for heel-strike then roll forward to the toes (ankle rocker motion). This gait deviation results in decreased power for toe off because the body is not in the correct position for forward acceleration. With this gait deviation there is also less oscillating movement of the center of gravity because of the restricted pelvic motions and therefore according to current gait theory, there should be energy conservation, but on the contrary cane users report an increase in energy cost with cane use.

Conventional canes and walking aids may have a negative impact on balance by interfering with anti-gravity muscles disposed for providing the postural tone that keeps us standing up. The body is always in motion even while appearing still. Minute oscillatory movements countering the effects of gravity occur throughout the body and gross movements are not started until they are in phase with normal oscillations. The normal postural Anterior-Posterior sway while standing is controlled essentially by the action of the soleus and tibialis.

### SUMMARY OF THE INVENTION

The instant invention, as illustrated herein, is clearly not anticipated, rendered obvious, or even present in any of the prior art mechanisms, either alone or in any combination thereof. Therefore, it is an object of the instant apparatus to aid in the proper function of the myofascial structure while walking. This will lead to an upright posture with chest lifted upwards, shoulders relaxed downward, heel-to-toe roll of the foot allowing the correct angle for heel-strike (loading) push-off from ball of foot (unloading), and natural pendulum swing of the arms and legs.

During normal foot function, there is a cycle of pronation and supination accompanied by internal and external rotation of the lower leg via hip rotation/pelvic motion. At heel-strike/deceleration the lower limb approaches the ground with a slight angle and as a result the foot strikes on the outside of the heel bone. Next the foot's bone and muscle structures loosen and the foot pronates at the ankle joint. Pronation is the inward roll of the foot and occurs as the outer edge of the heel strikes the ground and the foot rolls inward allowing the foot to function as a mobile adaptor, adjusting to the variances in terrain.

During midstance the foot converts from a mobile adaptor (pronation) to a more ridged lever in preparation for propulsion/acceleration (supination) in toe-off. Supination is the outward roll of the foot as the heel lifts off the ground and the forefoot and toes are used to propel the body forward. As the foot supinates the lower leg starts to rotate externally.

Conventional canes make no accommodation for the normal movement of the foot when standing or walking and may have a negative impact on balance. Downward push to keep the cane stable works against the natural minute body movements needed for maintaining upright posture and balance during locomotion. Regularly utilized canes may appear to be helpful if a person is using a walking assistant for balance, however, over time reliance on a tool that decreases the activation of the muscles required for postural balance ultimately will cause less stability and an increased weakness in the very muscles a person is attempting to assist. In addition, the body's center of mass is higher during downward push, which makes the body more unstable.

The instant system, deemed the Rocking Stick™, allows for movement at all times and in any direction and does not raise the body's center of mass, as the system is not fixed to the ground for stability, but rather follows the normal motion of the human body. Stability with the Rocking Stick™ is achieved by the ability to be able to immediately respond and restore equilibrium when a person loses balance. The Rocking Stick™ user has the shaft handle forward so the weight is forward of center, opposite of how users of conventional cane are instructed to hold the cane or walking device.

This configuration provides the extended length needed to place the posterior end at the required distance when swinging the stick forward so that the roll forward puts the shaft in the position that is mirroring the leg throughout—imagining that the hand and handle mirror the knee motion. If the hand is either in the center or to the rear of the rocker, it decreases the elevation upon initial placement which then brings the shaft perpendicular to the leg when it is straightening creating a slight vaulting upward resulting in the same limited rotation of the pelvis, decreasing the stretch during heel-strike and toe-off. The results are the same as if you had shoulder depression but in this case the shaft is pushing up, rather than you pushing down.

The Rocking Stick™ with its curved base and rubbery tread allows natural lateral motion during gait cycle just as if it were the foot itself. The rounded edge with tread available when tipped on its side provides movement in any direction. The open, flattened palm of the hand since it is more relaxed without the need to clench which allows for proprioceptive feedback from the compressive quality of the rubber tread.

Because forces are dispersed over a larger base there is little chance for Rocking Stick™ to slip away. The Rocking Stick™ decreases the impact of shear forces at heel-strike and increases terrain adaptability as the foot pronates naturally while preserving the momentum of forward propulsion. Balance may also be affected when using a conventional cane during toe-off when greater downward force is applied to the cane for stabilization and transference of body weight and the cane's frictional hold shifts, slips forward and creates disequilibrium.

The Rocking Stick™'s tread and curved footing provide gripping contact and as the stick rolls forward it has continuous contact with the ground and provides a much larger surface area which makes it difficult for slippage to occur in any direction. In addition there is no need for any forceful push so the Rocking Stick™ helps maintain balance in all weather conditions and varied terrains.

By design, if a user is pushing directly downward on the Rocking Stick™, the user is not employing it properly and it will not support the soft tissue structures which are how the load is transferred. Both the conventional cane and the Rocking Stick™ are confined to Newton's Laws of Motion. The first law is the Law of Inertia—an object at rest will remain at rest unless acted on by an unbalance force. An object in motion continues in motion with the same speed and in the same direction unless acted upon by an unbalance force, in many cases a friction vector.

The utilization of canes involves a non-fluid, stop and start, activity because there must be downward push on the cane (stop) to create enough force to carry the head, arms, and torso forward during single stance and momentum is lost and the recoil arrangement in the facial tissue cannot provide the essentially free energy. Using conventional eccentric/concentric contractions of muscle requires more energy and therefore is more tiring. With the Rocking Stick™, as a person swings the stick forward, the weight of the foot piece is enough to create forward motion and momentum pulling the person in a forward direction. The arced base rolls in the forward direction without stopping and forward motion is continued. The second law (Force=Mass×Acceleration) and the third law (for every action there is an equal and opposite reaction) together explain why pushing downward on a cane is met with equal upward force (ground force reaction) and this force accelerates the body upward requiring energy to be used, stopping the forward motion of walking.

The same laws of motion apply to the Rocking Stick™ as it facilitates normal gait: at heel strike the friction between the heel and the ground causes a horizontal force to act backwards against the foot creating braking action on the body where energy is stored and then at toe-off the friction force is forwards where the stored energy is used for forward acceleration.

The normal gait cycle has two phases—stance and swing. Stance phase begins the instant the heel contacts the ground (heel strike) and ends when only the toe of the same extremity is on the ground (toe-off). The foot is in contact with the supporting surface at all times. The stance phase makes up 60% of the gait cycle. The stance period consists of initial contact (heel strike), loading response (foot flat), mid-stance (heel off) and terminal stance (toe off). The swing phase of gait is the interval in which the foot is not in contact with the ground. The swing phase makes up 40% of the gait cycle. The swing period consists of initial swing (acceleration), mid-swing (extremity passes beneath body), and terminal swing (deceleration). Additionally, there are times when both feet are on the ground or double limb support, and times when only one foot is on the ground, single limb support. The mid-stance period of the stance phase begins with the contralateral toe-off and the body's center of mass is directly over the reference foot. Terminal stance period of stance phase begins when the center of mass is over supporting foot and ends when the contralateral foot contacts the ground. Thus, when gait deficiencies exist, based on classical theory of gait, assistance would be required, that being a walking aid during the mid-stance to terminal stance phase when the affected/injured/weak limb is supporting the superincumbent mass (head, torso, arms) and the downward force of gravity acting on that mass.

With the Rocking Stick™, the most crucial assistance is during the heel-strike and toe-off periods of stance, both double limb support, rather than during the mid-stance, or single limb support period of the stance phase. The curved base of the Rocking Stick™ preserves forward momentum with the contralateral forward arm swing at heel-strike and dissipates impact by rolling in the direction of force, prolonging the duration of the impact with the length of the foot piece, and following through the full range of motions with the extended elevation.

Fundamentally, locomotion is the translation of the body's center of gravity or center of mass along a pathway requiring the least expenditure of energy. Center of mass or gravity is a unique point where weighted relative position of the distributed mass sums to zero and all of the body parts balance through space. The center of mass for most people is anterior to the second sacral vertebra when standing. According to popular belief, to expend the least amount of energy during locomotion the body must travel in as straight a line as possible and reduce any other type of movement of the body's center of gravity beyond normal excursion limits.

In classic or pedestrian theory of locomotion there are six determinants of human gait that represent adjustments made by the pelvis, knees and ankles that help to keep movement of the body's center of gravity to a minimum in the horizontal and vertical planes, smooth the pathway, and decrease energy expenditure. The six determinants are pelvic tilt, pelvic rotation, knee flexion in the stance phase, foot and ankle mechanisms, and lateral pelvic displacement. In classical theories of locomotion, some have added alternating arm movements as a possible secondary determinant but no specific role has been identified in these theories other than adding momentum.

Normal excursion of the pelvis is when the pelvic (iliac) crest on the side of the swing leg drops or tilts (5 degrees) below the horizontal at midstance (single-leg support) of the opposite leg; pelvic rotation is during swing phase on ipsilateral side when pelvis rotates anteriorly (4 degrees) and on stance side posteriorly (4 degrees); and lateral shift occurs during stance phase when trunk and pelvis shift laterally toward the stance phase leg (1 inch).

During the normal pattern of gait within each gait cycle, the center of gravity is displaced in the vertical direction (sagittal plane) and in lateral direction in (frontal plane). Movement of the lowest displacement occurs at double support when one limb is in toe-off and the other limb is heel-strike. Movement of the highest displacement occurs at midstance when the one limb is supporting all body weight. When a person puts the vertical and lateral displacement together, the center of gravity travels within a box 2 inches tall and 2 inches wide.

The pathway is a smooth sinusoidal curve (figure eight shape in two directions). Classical theory dictates that any interference with normal gait motions will result in an increase in energy expenditure (metabolic activity) as the amplitude increases therefore, normal gait patterns are to conserve energy thereby making the process of walking easy and efficient.

The normal gait cycle phases and the determinants of gait have been thoroughly studied. It has been observed that compensation is reasonably effective with the loss of one determinant of which that at the knee is most costly (results in increased lateral displacement and limited downward movement in double stance due to knee immobility). Loss of two determinants makes effective compensation impossible and the cost of locomotion in terms of energy increases threefold with an inevitable drain upon the body economy.

Therefore, once downward push on a cane or walking aid has been initiated, multiple determinants are compromised as follows: pelvic tilt and pelvic rotation which result in inadequate lengthening of the swing limb from restricted hip extension; the inability to bend knee due to upward vaulting to shift body weight over single leg which interferes with hip extension of swing leg; foot and ankle rocker mechanisms (dorsiflexion and plantarflexion) which are necessary for heel strike and toe off resulting in a reduction of forces and loading on spine for both acceleration (kinetic energy) and deceleration (stored potential energy); and the compromised secondary determinant of arm movements which results in decreased torso rotation and contralateral arm swing (momentum). Research has shown that restricting normal arm swing and holding arms motionless require 12 percent more metabolic energy than if the person was to swing them naturally.

And thus, it is unequivocal that conventional walking aids and canes, which rely on downward push to provide support by holding foot or cane base to ground, increase energy cost for user.

Current walking aids or canes are designed based on the popular theories that human movement is accomplished through a system of rigid levers and that locomotion is a transportation system for the upper body via the lower limbs. Additionally, it is believed that energy efficiency results from efforts that keep the center of gravity travelling in as straight a line as possible with minimal excursions and it is believed that this is the role of the determinants of gait. If these theories of movement are accurate the net result should be physical relief to the user by: providing a longer moment arm (lever) with cane to decrease joint force; by using muscles of the torso as a method to lift and offload body weight; and by reducing the overall movement of the center of gravity (there is a vertical increase but downward excursion is reduced); however, this is not the case. People with difficulties walking often opt to limp, waddle, shuffle, and hobble rather than use a walking aid or cane.

For these reasons, people regularly abandon use of a cane even under the recommendation of their doctor. It appears that people will go to great lengths to avoid using a cane. Is it simply the appearance of being old and weak or is there something more significant occurring with consequences only perceived through direct user experience. It seems that people prefer to go without assistance only to succumb to a walking aid if they find it physically impossible to move from point A to point B or their fear of falling pushes them towards using a cane. Users complain about the muscle strain and difficulty of use, but which components truly makes canes so challenging to use?

Addressing this, current devices are challenging to use because their design is based on outdated theories of human structure and movement. The design is based on old science and the belief that bones are the load bearing structure—if a person possesses pain in joints and bones, then reducing the load on the bones should reduce the pain. The function of the cane is to reduce compression on bones and joints and this is accomplished by limiting joint range of motion, preventing muscles from contracting through flexion and extension, and preventing ligaments from pulling on the bones. These actions will cause weak muscles and imbalanced fascia. A person will not be able to strengthen muscles or maintain current strength when a cane is utilized. All canes and walking aids available today function by creating a fixed, immovable contact with the ground as the user moves. Downward push on canes may create or augment an existing abnormal or pathological gait.

Conventional canes and walking aids are not designed to allow the myofascial tissues and the tension web to function properly and create the tensile strength necessary to transfer load efficiently across the body. The load is carried by the upper body and down through the cane to the ground. It has been reported that strength and metabolic demands can be excessive with canes and canes may interfere with the ability to maintain balance in certain situations. Research has shown that crutch walking, which uses the same muscles as cane walking, requires more energy than walking with prosthesis. Orthopedic textbooks describe proper cane use to be in contralateral hand which results in up to 60 percent of body weight transferred through the pelvis via arm and latissimus dorsi placing a great deal of stress on few muscles.

Fascial sheets and the underlying muscle tissue work together to for a force amplification system called the hydraulic amplifier effect. Stretching or tensioning the fascial sheets increases the efficiency of the associated muscles by which can be brought about by: tensioning of the muscles within the fascial sheet like the tensor fascia lata in the thigh and gluteus maximus; muscles contracting deep in the fascial layer which will tighten muscles within the same sheet; and the natural momentum of the body which can stretch and elastically load tissue.

The swing of the arm will tension and elastically load the tissue and the swing of the leg will tension the fascia of the hip extensors. All three of these mechanisms are often combined in functional movements that work long muscle chains. It is estimated that the hydraulic amplifier can increase the efficiency of muscular work by up to 30 percent. It is said to like shrink wrapping which helps to disperse the force through a greater proportion of tissue.

In walking, there is tensioning of the gluteus maximus and the latissimus dorsi muscles which are connected through the thoracolumbar fascia. The fascial sheet and its deeper connections will therefore be tensioned. The tensioning force of the fascia will meet the expansion of the muscle within it created easy force transfer and recoil.

Mobility aids should improve balance control by providing mechanical advantages; however, some research indicates that mobility aids are significantly associated with falls and injuries. Studies show that 30-50% of people abandon their walking aid soon after receiving it. Furthermore surveys indicate that almost half of the reported problems associated with cane use fall under the category of difficult and/or risky to use. Problems reported include discomfort, pain, and injury. A device designed to provide support should make it easier to walk with the device than without. The repetitive stresses on upper-extremity joints resulting from chronic cane use can contribute to pathologies such as tendonitis, osteoarthritis, and carpal tunnel syndrome.

People with arthritis who often use canes to reduce weight bearing on their legs are at risk of developing joint inflammation from repetitive forces in upper extremities. Upper limb loading can even lead to scapular stress fracture with extensive use of a cane. There are several attentional, neuromotor, musculoskeletal, physiologic, and metabolic demands associated with using these devices. The numerous detrimental consequences of walking aids and canes currently on the market indicate a need for a paradigm shift around human movement and theories of locomotion in search of new and improved designs for safer and more effective walking aids.

Locomotion is basic to survival. Human evolutionary adaptation to use the gravitational field to our advantage is optimal if energy is conserved during locomotion. The Rocking Stick™ is based on new ways of thinking about energy conservation in the gravitational field, human movement, and force transmission. The design and function of the Rocking Stick™ is grounded in theories and research from the following scientists: Dr. Serge Gracovetsky (Spinal Engine Theory); Dr. Andry Vlemming (Muscle Sling Systems and the thoracolumbar fascia); Thomas Myers, LMT (Anatomy Trains and the myofascial lines); Dr. Peter Huijing (Myotendinous Force Transmission); Dr. Robert Schleip (Fascia as an Organ of Communication); Tom Flemons (Bones of Tensegrity); and Dr. Steven M. Levin (Biotensegrity).

The Rocking Stick™ allows the body to move naturally and maximize the energy exchange from axial torque rotation and the viscoelastic nature during heel-strike and allows the fascia to function normally and efficiently transfer the load across the fascia web through lines of pull and muscle sling systems. The Rocking Stick™ reduces pain when walking because the Rocking Stick™ is based on the science of biotensegrity.

Thus, forces primarily flow through our muscles and fascial structures and not in a continuous compression manner through our bones. In fact, our bones do not directly touch each other, and are actually “floating” in the tension structure created by our fascial network. Thus, biotensegrity represents a significant conceptual shift from the common sense view that our bones are the load bearing structures in our bodies like the framing of a house.” If the tension network (fascial web and associated muscles) becomes weak due to injury or lack of appropriate exercise, then it cannot necessarily hold the bones apart anymore. Thus, the experienced forces will start passing compressively through the joints.

If bones end up touching it becomes a source of dysfunction and leads to inflammation and trouble. Pain in bones and joints from injury or overuse can be reduced or even eliminated when support is provided for the soft tissues. The Rocking Stick™ can strengthen and rebalance the tension in the muscles so the affected joint(s) gain more space reducing pain. The Rocking Stick™ can reduce and/or eliminate the symptoms of osteoarthritis and may, help to halt the progression and/or prevent osteoarthritis when used properly. The Rocking Stick™ can aid in rehabilitation and be used as a fitness tool because it facilitates normal gait and thus normal muscle function.

From an evolutionary approach, there must be an evolutionary advantage to human upright posture, bipedalism, existence in gravity, and locomotion as a fundamental action. According to classical theories of bipedal locomotion, the legs do all the work and are more or less energy conservative. Newton's first law of gravity encourages the straightest trajectory for the body's center of gravity, yet this is not possible. Even while standing still our body oscillates moving slightly to and fro to maintain postural balance. Some theorize that there is an evolutionary advantage to this strange interaction with the gravitational field and that again from an evolutionary point of view, the head, arms, and trunk must serve a purpose, rather than passive non-contributing elements in the locomotion process.

Newton's second law dictates that sprinters with powerful legs but emaciated upper bodies should be the fastest, however, world record holders in sprinting have well-proportioned, muscular upper bodies. The muscular power available in the mass of the upper body is somehow translated into forward push. Efficient rotation of the pelvis requires a pull in the horizontal plane but there are no muscles capable of this. An evolutionary-based theory of locomotion can account for these inconsistencies: the “spinal engine” theory of human locomotion based on the research of Dr. Serge Gracovetsky.

Gracovetsky's thesis is that the evolutionary pressures for efficiency on land forced the spine of our fish ancestors to evolve into the human curved spine. The lordotic spine converts the primitive piscine lateral bend into an axial torque driving the pelvis. This coupled motion mechanism serves as the drivetrain for human ambulation. Coupled motion occurs within a joint system, part and parcel to the primary motion. Two or more motions are considered coupled when it is not possible to produce one motion without inducing the second motion; spinal coupling is due to the morphological shape of the facet joint surfaces and the connecting ligaments and spinal curvatures.

In the classic or pedestrian model of gait, the pelvic motion is said to be driven from the legs but in the “spinal engine” model it is the spine's lordosis (curvature of the lumbar spine) which drives pelvic motion. In this model the role of the legs is to amplify the motion of the pelvis, therefore the major events of the gait cycle (heel-strike and toe-off) should be synchronized with the motion of the pelvis which has been found to be true. The heel-strikes and toe-offs occur near the peaks of pelvic motion in each plane allowing for maximal stride length and energy exchange in the gravitational field. Efficiency comes from unrestricted movements and energy exchange while ambulating. Use of traditional walking aids and canes reduce mobility in limbs and spine and increase energy cost as natural gait patterns are altered.

The determinants of gait, this application opines, are not to “minimize movement of the center of gravity” as the means to conserve energy, but rather to allow a very specific oscillation of the body in the gravitational field allowing alternating loading and unloading of the spine, driving the spinal engine. Loading occurs in heel strike (compression) and toe off (tension). Walking is a transformation of energy rather than energy expenditure. The evolutionary process of upright bipedalism takes full advantage of the viscoelastic properties of the fascia and ligaments. The spine-pelvis-leg system is optimized to permit locomotion at minimal energy expenditure.

Traditional canes and walking aids interfere with the determinants of gait and restrict pelvic movements which are needed for lordosis, thereby interfering with the drivetrain and the spinal engine; the Rocking Stick™ does not interfere with the determinants but rather enhances these determinants to maximize energy exchange. The Rocking Stick™'s curved foot moves with the ankle rocker motion of the foot. There is no downward push necessary and downward push is not possible when using the Rocking Stick™ as it has been designed to be used. Support is achieved by following the natural movements of the body during a normal gait cycle without interfering with the viscoelastic properties and natural function of the fascia, which provides energy exchange and force transmission.

The control of lordosis permits the lumbodorsal or (thoracolumbar) fascia to be set under tension and transmit the forces generated by the hip flexors. Flexion and extension requires lordosis which is a trademark of our species. Lateral bending with lordosis generates axial torque controlling the pelvis. The compressive pulse during the heel strike when the body is lowered tends to stiffen the spine which permits large and rapidly varying torques to be sustained within the spine.

The following description of how the spinal engine works, within the locomotion process, is the work of Aline Newton from “Gracovetsky on Walking”. Starting with the left leg, as the toes push off the ground the hip extensors fire and with the help of the fascial connections, extend and raise the trunk, decompressing the spine as it bends to the left. The spinous processes rotate to the right and the rotating pelvis brings the acetabulum forward. Then as the trunk falls back to the ground the heel contacts the ground, the pelvis tilts and the right ilium is lowered. The compressive pulse generated at heel strike travels back up the spine. The pulse stiffens the fascial lines and increases the spine's torque strength.

The power from the leg muscles and fascial connections attached to the transverse and spinous processes will be effective in derotating the spine. The pulse continues upward and the intervertebral joints extend and derotate. At the thoracic spine the pulse helps counter-rotate the pelvis and shoulders which is the basis of the contralateral movement of gait that is seen in the arms and legs. The latissimus dorsi and the arms play a key role in the chain of rotation. Oh highest import, downward push, when using a cane or walking aid interferes with this natural rotation and alters the role of the latissimus dorsi in the gait process.

The Rocking Stick™ inherently assists with natural torso rotation and permits normal function of the latissimus dorsi during the locomotion process.

At the cervical level, the pulse generates an axial torque, which is reversed due to the organization of the facets. The effect of this is to cancel the motion of the shoulders so that the head can remain stable, preserving the need for stabilization of the eyes. As the pelvis returns to horizontal, and the spine to vertical, the facets get aligned and the torque continues to be transmitted through the annulus fibrosus. The spinal facets and the intervertebral discs are a complementary system spelling each other to transmit the torque with maximum efficiency (annulus' torque is maximum during double stance when the body is at the lowest and facets' force transmission is minimum). This model shows that the power goes from the leg to the spine directly. The role of the leg-pelvis system is to transform the raw variable heel strike pulse in to a well-conditioned pulse to feed the spinal engine.

The muscle mass of the legs has enough chemical energy required for walking and running. The legs also provide contact with the ground modulating the timing, duration, and amplitude of the energy pulses generated at heel strike before transmitting to the spine. The spine uses this energy to fuel its axial rotation, which in turn rotates the pelvis. The anterior posterior motion of the pelvis prevents the lumbodorsal fascia from continuously transmitting forces. During double stance, the lordotic spine switches on the erector spinae muscles and slackens the posterior ligamentous system. Conversely, at heel strike, the posterior ligamentous system being tightened can transmit forces thereby permitting the erectors to relax and rest. For the spinal engine to be charged with energy, the hip extensors have to be free to extend.

The hip extensors power the system by helping the spine extend and also by stretching the psoas which increases the stored elastic energy, before it contracts to flex the hip in toe off. The chemical energy liberated by the powerful hip extensors is contained in the pulse generated at heel strike. That energy must be recovered and returned to the oscillating structure or the energy cost of gait will increase. Muscles and ligaments share the forces transmitted across the sacroiliac joint delaying onset of fatigue of the back. The arms play several important roles in this model of locomotion. Their inertia provides a key element in the counter-rotation of the shoulders and pelvis.

Through the latissimus dorsi muscle, they also help to stabilize the spinous processes, and to derotate the spine after heel strike. Problems in the freedom of movement of the arms and shoulder girdle will eventually show up in gait. If the rhomboids hold a contraction, as evidenced in the downward push on a cane, it will interfere with the ability of the hip to extend, thus preventing the psoas from being stretched and lessening their effectiveness.

As described by Gracovetsky, “Gait is the result of a sequential transformation of energy intended to redirect the quasi-vertical pull of the hip extensors to a horizontal pull capable of rotating the pelvis. Beginning with the legs, muscular chemical energy is first used to lift the body into the earth's gravitational field, where the chemical energy is stored in potential form. When the body falls downward, this potential energy is converted into kinetic energy that is in turn stored in a compressive pulse at heel strike. The pulse properly filtered by the knees and the massive ligamentous structures across the sacroiliac joint travels upward and reaches the spine with the proper shape and timing.

The energy is then distributed to each spinal joint to counter-rotate pelvis and shoulder, while derotating the shoulders stabilizes the head.” Locomotion can be viewed as a coordinated sequence of rotations in relation to the ground and the arms. In this model, rather than weight lifting, the image is of walking as a flowing transformation of energy, with minimal effort; arms and legs needing to be evenly developed and smoothly inter-related.

The design and function of traditional walking aids and canes currently available do not permit a flowing transformation of energy because their design interferes with the heel strike needed to capture the energy pulse. Traditional walking aids and canes increase the expenditure of energy by requiring user to repeatedly lift the body against gravity. The intended goal of this lifting effort is to make walking easier by reducing pain and/or providing support for weaker lower body muscles. This is a misconception because eliminating or greatly reducing the compressive force of heel-strike and propulsive force of toe-off, prevents the proper loading and unloading of the spine.

The spinal engine will not operate efficiently. Studies have demonstrated that the biceps femoris (quads) and the hamstring group as a whole are active at the end of swing phase through the early loading of the stance phase. The biceps femoris effectively starts the spinal engine. During heel strike the ipsilateral hip and contralateral shoulder are in flexion pre-loading the fascia specifically the gluteus maximus and latissimus dorsi or posterior sling. The compressive pulse generated at heel-strike is essential to the locomotion process and not available when the body is engaged in a downward push action on the cane. The shape of this pulse must be very specific if maximum energy is to be transferred from the earth's gravitational field to the rotating pelvis. The body will not have access to this stored energy and will require chemical energy derived from the metabolic activity of muscles as the body is lifted against gravity. The Rocking Stick™ does not interfere with the normal gait cycle and the workings of the spinal engine.

The Rocking Stick™ again inherently supports the proper functioning of the soft tissues (muscles, ligaments, and fascia) and disperses the load over a larger area while the spinal engine greatly reduces the energy cost making walking easier and less painful to the affected joint(s).

With traditional cane use, there is virtually no role for the legs other than to carry the torso just as pedestrian theory of locomotion dictates. Often an unfortunate consequence of cane use is seen with elderly users who eventually shuffle their feet from lack of gluteal muscle strength required to accelerate the swing leg forward. Current walking aids and canes reduce lower body muscle involvement slowly weakening the very muscles needed for walking—including muscles of the feet, legs, pelvis and lower back. Cane use exacerbates the problem and ultimately becomes part of the problem. Walking becomes an upper body weight lifting exercise, consisting primarily of upper body isometric contractions.

The way canes are intended to be used their design relies on the muscles of the upper body to transfer as much load as possible across the pelvis to the ground via arm and cane. Force transference is dependent on the stability of the sacroiliac joints of the pelvis. A primary function of the pelvis is to transfer the loads generated by body weight and gravity during standing, walking, and other functional tasks. During walking the sacroiliac joint must lock and unlock on alternating sides allowing for maximal efficiency of the pelvic differential-like mechanism.

The sacroiliac joint has a high level of stability from the self-locking mechanisms (form closure) of the pelvis, which comes from the anatomy and shape of the bones in the sacroiliac joint and also the muscles supporting the pelvis (force closure—compression of the two joint surfaces together by muscles and fascia). Although form closure provides stability to the sacroiliac joints, for mobility to occur further joint compression and stabilization is required to withstand a vertical load. Muscles, ligaments and the thoracolumbar fascia all contribute to force closure. Force closure creates greater friction and therefore increased form closure. The ilium and sacrum only meet for approximately a third of the surfaces so the rest of the stability between the bones is provided by the action of the ligaments.

There are two major myofascial stabilizer systems of the body, the inner unit and outer unit. The inner unit muscles function as stabilizers, or rather provide segmental stability so the body can be flexible for postural balance. Inner unit muscles effectively stabilize the spine and sacroiliac joints at low levels of contraction with low susceptibility to fatigue. The muscles are relatively small with less potential to generate force. The outer unit controls the range of motion, generates movement and provides gross stability.

During gait there is a consistent activation of the inner unit, this activation though low, is strong enough to provide the correct amount of stiffness to joints which allows for more motion of the outer unit. The inner unit muscles consist of the transversus abdominis, multifidus, diaphragm and pelvic floor musculature and are under separate neurological control from the larger outer core musculature. The thoracolumbar fascia system envelops the inner unit musculature to create the body's own natural weight belt. The thoracolumbar fascia (lumbodorsal fascia) is a deep investing membrane, which covers the deep muscles of the back of the trunk.

The outer unit consists of four systems, the posterior oblique, deep longitudinal, anterior oblique and lateral. These systems, also referred to as myofascial slings, are dependent upon the inner unit for the joint stiffness and stability necessary to create an effective force generation platform. The slings that provide force closure and stability in the pelvic girdle include the anterior oblique, posterior oblique and the deep longitudinal slings. The classification of muscles as a myofascial sling is based on longitudinal connections between adjacent myofasciae, such that the line of fibers is relatively continuous from one structure to the next rather than bending at acute angles.

Extensive study on the four outer myofascial slings have been documented by Andry Vleeming in relation to their role in stabilizing the sacroiliac joint and how force can be transmitted through these myofascial linkages. Linkages create slings and when the ideal vectors of pull are aligned the slings function optimally and increase movement efficiency, which is defined as the integrated balance between the central nervous system and the muscular system.

Movement in the sacroiliac joints is made possible by the fibrocartaligenous structure of these joints. It is both necessary and desirable that these joints move to allow transmission of forces between the lower limbs and spine and to act as a proprioceptive feedback mechanism for coordinated movement and control between trunk and lower limbs. The posterior oblique sling system is a significant contributor to load transference through force closure during the rotational activities of gait. The posterior oblique sling consists of the superficial fibers of the latissimus dorsi blending with the superficial fibers of the contralateral gluteus maximus through the thick posterior layer of the thoracolumbar fascia. The superficial gluteus maximus then blends with the superficial iliotibial band of the thigh.

This sling system runs at a right angle to the joint plane and in effect will cause closure of the joint as the latissimus and contralateral gluteus maximus contract and approximate the posterior aspects of the innominates. The action of these muscles along with the fascial system is thought to both resist the rotation of the pelvis that would occur during gait as well as store energy to create more efficient movement (Spinal Engine Theory). The thoracolumbar fascia helps to transfer load from the torso to the pelvis and lower limbs through the sacroiliac joint. The ligaments of the sacroiliac joint and many of the surrounding muscles interact with the thoracolumbar fascia and it has been described as a large transmission belt.

Force closure can be increased indirectly contingent upon the anatomical connections of the gluteus maximus and the thoracolumbar fascia with the sacrotuberous ligament. Activation of the gluteus maximus occurs in concert with activation of the contralateral latissimus dorsi extending the arm in concert with the propelling leg. Dorsiflexion of the foot and activation of the biceps femoris just prior to heel strike “wind up” the thoracolumbar fascia mechanism. The synergistic contraction of the gluteus maximus and latissimus dorsi creates tension in the thoracolumbar fascia, which will be released in a pulse of energy that will assist the muscles of locomotion, reducing the metabolic cost of gait (Spinal Engine Theory).

The downward push on a cane interrupts the myofascial vectors of pull, and decreases foot dorsiflexion, heel-strike, and form/force closure of the sacroiliac joints. Downward push on a cane or walking aid activates the latissimus dorsi in a concentric or isometric contraction engaging the muscle in such a way that it is not possible to extend the arm forward in a contraction of the latissimus dorsi necessary for counter-rotational movement. The posterior sling system cannot function properly in generating axial torque through counter rotation because there is no arm extension. In addition hip extension from the gluteus maximus is diminished resulting in a weak or non-existent heel strike thereby increasing the metabolic cost of gait. The heel-strike is how the compressive pulse is generated. Without stored energy, walking becomes very difficult.

The heel-strike is how force closure is initiated across the sacroiliac joint. Without force closure, less body weight can be transferred through the fascia resulting in more muscle recruitment and greater metabolic costs. Proper heel-strike is essential for maximal force and load transmission. The design and correct use of the Rocking Stick™ facilitates proper functioning of the sacroiliac joints, the posterior and anterior sling systems, and the heel-strike and toe-off during gait. The rolling foot piece of the Rocking Stick™ parallels the heel to toe ankle rocker motion.

As we walk, just prior to heel-strike, the hamstrings become active. The deep longitudinal sling uses the thoracolumbar fascia and paraspinal muscle system to transmit kinetic energy above the pelvis, while using the biceps femoris as a communicating link between the pelvis and lower extremity. The deep longitudinal sling includes the deep multifidus muscles which are attached to the sacrum, the deep layer of the thoracolumbar fascia and the sacrotuberous ligament via the long head of the biceps femoris muscle. Contraction of the deep multifidus muscle will rotate the sacrum forward thereby increasing the tension of the ligaments surrounding the sacroiliac joints, and lock the joints in, thus increasing stability. The contraction of the deep multifidus muscles increases the tension of the thoracolumbar fascia, giving rise to a “pumping up” phenomenon which in turn increases the compression of sacroiliac joints.

The anterior oblique sling consists of the external oblique, internal oblique and the transversus abdominis via the rectus sheath, blending with the contralateral adductor muscles via the adductor-abdominal fascia. This will cause force closure of the symphysis pubis when contracted. To clarify the point that movement originates in the spine or core, Gracovetsky describes torque generation by an S-shaped spinal column. He exemplifies the point that the legs are not responsible for gait, but merely instruments of expression, by showing in his research that a man with no legs whatsoever can walk.

In the spinal engine, the kinetic and potential energies of the oblique abdominals are primarily responsible for creating the torque that drives the spinal engine; the oblique abdominal being best situated to create rotary torque. The oblique abdominals, like the adductors, serve to provide stability and mobility in gait. Both sets of muscles contribute to stability at the initiation of the stance phase of gait, as well as to rotating the pelvis and pulling the leg through during the swing phase of gait. Contra-rotation is minimized or eliminated when engaging the arm in downward push on the cane to make ground contract and create enough stability, frictional hold, to lift the body weight to reduce the load on the joint(s).

Shoulder movement is restricted and this causes a restriction in pelvic rotation which ultimately reduces axial torque and the energy needed to drive the spinal engine. Walking aids and canes do not work in conjunction with the natural mechanisms that are responsible for reducing metabolic costs and efficient force transmission.

The lateral sling system therefore consists of the gluteus medius, gluteus minimus and ipsilateral adductors. The lateral system stabilizes the body in the frontal plane. During a single-leg stance the hip abductors and adductors of the supporting leg work in concert with the opposite quadratus lumborum to stabilize the pelvis. The oblique (both internal and external) musculature is also synergistic to secure a stable spine and pelvis. Overuse of the lateral sling system may result in system fatigue and put extra strain on passive supports such as ligaments and discs. Walking aids and canes appear to rely on the frontal sling system more than the other sling systems due to downward push and interference with the functioning of the posterior and anterior sling systems. As a person pushes downward, the body is lifted in the frontal plane weight is transferred. Advancing with a cane is more side to side in the lateral plane than forward in the sagittal plane as would occur in natural gait and when using the Rocking Stick™.

Effective force transference during locomotion is dependent upon utilization of the fascia, particularly the large area on the back called the thoracolumbar fascia whose lines of pull are continuous with the gluteus maximus and the contralateral latissimus dorsi (forms an “X” across the back).

Gracovetsky determined through linear algebra that muscles alone are not able to support heavy loads and transmit forces and found that the fascia is a critical structural component. Bioengineers have typically considered only Newtonian mechanics as their basis for calculations.

“Biologic structures are low energy consuming, open systems, constructed with soft, viscoelastic materials that behave nonlinearly. Calculating loads with the body as a lever-beam, linear Newtonian model will create forces that rip muscle, crush bone and exhaust energy.” (Levin) Biologic structures exist independent of gravity, are omni-directional, and can exist and adapt to water, land, air and space. Fascia displays the nonlinearity characteristic of all biologic tissues: continuous tension. This system of biomechanics is called tensegrity or biotensegrity—a structural system of continuous tension and discontinuous compression.

According to Stephen Levin the laws of leverage act differently when applied within the tensegrity system so that forces generated are dissipated throughout the system and may actually strengthen the structure. The thoracolumbar fascia has been found to be so efficient at transmitting forces that the muscles can shut down and be in a state of muscle relaxation, minimizing stress. When the fascia works it costs nothing in metabolic and energy consumption. Gracovetsky found that fascia and muscles switch back and forth oscillating in the gravitational field. This requires a specific spine and pelvis coordination which is controlled by lordosis (inward curve in lumbar and cervical regions of the spine).

Control of lordosis is done by the psoas muscle in the front and the multifidus in the back and can be accomplished with trunk flexion or pelvic rotation. Lordosis controls the distribution of load between fascia and muscle. Gracovetsky found that lordosis during a normal gait cycle changed frequently from flexion to extension during heel-strike and toe-off. Lordosis is reduced with cane use due to restriction of pelvic rotation and abnormal gait. With reduced pelvic movement, the psoas tightens and shortens and pulls the body forward. The Rocking Stick™ promotes lordosis and correct functioning of the multifidus and the psoas because its design allows user to walk with normal gait and natural upright posture.

In Movement, Stability & Lumbopelvic Pain (2007), authors Vleeming, Mooney, Stoeckart describe a tensegrity model for the spine and pelvis highlighting the importance of the myofacial system. They say according to conventional wisdom, the human spine behaves as an architectural column or pillar and transfers the superincumbent weight through the sacrum, to the ilium, through the hips and down the lower extremities. The pillar holds the base in place with the pressing weight of gravity. In this traditional model, the sacrum, as the base, locks into the pelvis, either as a wedge or by some other gravity-dependent closure. In the tensegrity model the bones of the skeleton are not considered a supporting column but rather compression elements enmeshed in the interstices of a highly organized tension network. The bones, including the sacrum, ‘float’ in this network much like the hub of a wire spoke cycle wheel is suspended in its tension-spoke network.

A ligamentous tension system for support and stability is consistent with the known anatomy. If a bicycle wheel tensegrity structure is used as a model for the pelvis, the sacrum suspends as a compression element within the musculo-ligamentous envelope and transfers its loads through that tension network. The rim thus may distribute its load through tensegrity icosahedrons, which can withstand omni-directional forces rather than locally loading the forces at one point. A tensegrity model of this arrangement can demonstrate the linked, yet flexible, range of movement in the pelvis and the forces acting through the bones, ligaments, and muscles.

As stated earlier, biotensegrity researchers believe that the human body is primarily a tensegrity structure and our bones do not directly pass loads to each other. The forces primarily flow through our muscles and fascial structures. Bones float in the tension structure created by the fascial network and are not the load bearing structure. Tom Myers' Anatomy Trains describes the skeleton as a continuous compression structure and if the soft tissue is eliminated the bones will fall to the floor. Soft tissue holds the skeleton upright and the tone of the tensile myofasciae is the determinant of the balanced structure. To change the relationship among the bones, change the tensional balance through the soft tissue, and the bones will rearrange themselves. The Rocking Stick™ supports the myofascial structures and helps to provide the continuous lines of pull that can efficiently transfer load over the tissues and away from the joints.

The term fascia or myofascia describes the soft tissues component of the connective tissue system that permeates the human body. Fascia forms 50-60% of the mass of muscles. Fascia also includes the fibrous capsular layer of the vertebral discs and the periosteum (bones). Myers describes two bags which make up the body. The ligaments and periostea form a continuous inner bag around the bone and joint tissue and the outer bag is the muscle, with the containing bag itself being the investing fascia. The myofasciae provide a continuous network of restricting but adjustable tension around the individual bones and cartilage as well as the incompressible fluid balloons of organs and muscles which push out against this tensile membrane.

Most muscles send myofascial fibers and muscular slips to other connective tissues such as aponeuroses, ligaments, capsules, and fascia etc (Stecco, 2007) and transfer a significant proportion of their force through them. Fascia is now recognized as a continuous uninterrupted web of tissue that links the whole body into a single tensional network that extends from head to toe from front to back and from the skin to the deep insides (Schleip, 2012). The fascia maintains structural integrity provides, support and protection and acts as a shock absorber. The fractal-like system allows adjacent structures to slide in relation to each other during movement dampening the transfer of excessive forces. With the sliding and movements between the sheets, there cannot be tensegrity because that requires motion so there will be a break in the tensegral structure (pain). Developmental abnormalities, postural misuse, and injury to tissue will cause change in the tensional balance of others some distance away and might jeopardize their functionality as they adjust to a different structural configuration. The resolution of local conditions can then require a “whole-body” approach if tissues some distance away have become adapted to changes in the overall structural balance (Schleip, 2013)

Walking uses all of the fascial lines because you are moving on three different planes. Hallmark of locomotion is the contralateral arm swing and torso rotation. The Rocking Stick does not resist axial movement which occurs in the spiral fascia lines which twist up and down.

The harder tissues (bones) seem to float within this tensile network. Changes to bones result from changes in tensile network. Popular belief is that the skeleton is a continuous compressive structure with forces localized. Medicine works locally not globally. Tensegrity structures distribute forces along lines of tension. As described in Anatomy Trains, by Thomas Myers, “the extra cellular matrix (ECM) in the connective tissue (fascia) stores and communicates information across the entire body. Each change in pressure and accompanying tension in the ECM causes liquid crystal semiconducting lattice of the wet collagen and other proteins to generate bioelectric signals that precisely mirror the original mechanical information.

Stress passing through the ECM deforms the material stretching the bonds between the molecules which create a slight electric flow through the material known as piezo-electric (pressure) charge. This charge can be read by the cells in the vicinity of the charge and the cells are capable of responding by augmenting, reducing, or changing the intercellular elements in the area. The long molecules are polarized and orient themselves like compass needles along the line of tension (piezo-electric charge).

Individuals using walking aids or canes may not be able to efficiently utilize passive viscoelastic properties of muscle due to limited ability to drive forces rotationally through their bodies. Poor posture and instability may require more active co-contractions of muscles since they cannot access stored energy from elasticity in tendons. The extraneous muscle contractions increase energy expenditure and fatigue as joint range of motion decreases and there is less stretching of soft tissues through their lines of pull. Downward push on canes diminishes force capacity, which diminishes speed and momentum, and forces more reliance on shifting the trunk from side to side for force generation and forward progression. This is extremely inefficient and creates a downward spiral for users. The Rocking Stick™ does not interfere with rotational movement so user can access stored energy and forces are spread over large areas of the body minimizing strain in any one area including the affected joint(s) or muscle(s).

Thus, as continuously investigated here, there is great import in looking at the human body in with a global view when using a walking aid or cane. Cane use often causes pain in the shoulder or arm because forces are not distributed to a large area and the line of pull is shortened due to the need to push downward on the cane for stability. To maximize the distribution of forces, a person wants to use the entire line of pull as well as pre-stress the line of pull prior to loading. It has been found that tightening the myofascial structure evenly builds resilience and pre-stressing the structure prepares it to handle more loading.

Accordingly, Myers names the four major myofascial lines of the trunk also referred to as common pathways of functional force transmission: Superficial Back Line, Superficial Front Line, Lateral Line, and the Spiral Line. The first three myofascial lines align with the myofascial slings previously described. These lines (slings) transmit force and facilitate movement across multiple segments, store elastic energy, and increase tension around joint without compression.

Continuous tension is transmitted across all structures: an increase in tension in one of the member's results in increased tension in members throughout the structure. Fascia is a body-wide interconnected tensional force transmission system. The muscles and corresponding fascia are designed to work in combinations specifically to support locomotion and the activities required for survival. When we walk our spine is meant to have integrated whole body movement, not isolated movement of just the legs walking. We must travel from point A to point B by consuming a minimum amount of energy in a constant gravitational field while bones, muscles, and ligaments work as an integrated system to perform desired function with minimum stress. The musculoskeletal system of vertebrae is essentially an unstable structure subjected to the gravitational field with three basic components designed to support specific forces bones, ligaments, and muscles. The bones are good at supporting compressive forces, the ligaments support tension with their viscoelastic structure, and the muscles are the actuators.

Healthy joints, bones, muscles, and soft tissue allow sufficient compressive forces needed to provide a stable support structure and protection of the spine for the safe transference of body weight from one side to the other during gait. Weakened muscles, inflamed soft tissues, diseased or injured joints can impact the integrity of this structure and risk injury to areas of the body that are compensating for these deficiencies. Walking aids and canes are tools that should assist in the safe transference of the superincumbent weight by reducing the forces where the body is deficient while maintaining adequate structural support without causing injury.

However, downward push on a walking aid, such as a cane, often results in many negative biomechanical consequences for user including but not limited to interference with freedom of movement in ipsilateral arm and shoulder girdle; elimination or drastic reduction in contralateral rotation of the shoulder and pelvis (one of the hallmarks of normal human gait); and interference with contralateral extension of the hip and resulting heel-strike and toe-off.

There presently exists a need in providing a durable walking aid to overcome the aforementioned obstacles. Such a walking aid would eliminate the need for downward push necessary to maintain ground contact and stability, thereby promoting the normal movements of normal gait. Walking with a normal gait allows for upright posture and inner core engagement for spinal support and flexibility; torso rotation, arm swinging, and lordosis for maximizing energy exchange via the spinal engine; hip extension for heel-strike and toe-off which maximize lines of pull for greater load transference through the myofascial structures; and for stretching, strengthening, and rebalancing the myofascial structures for more optimal functioning of the Biotensegrity system.

Clearly, the present system, apparatus and accompanying methods of use and rehabilitation vitiate the need for, and illustrate the weakness of, a downward pushing motion. The instant system allows the user to push forward, which keeps the shoulders down. With the extended elevation at the point of push off from the foot, the body is naturally upright and core muscles can engage more efficiently. The psoas extends as the upright body moves forward in a natural walking posture.

The present system is designed to elongate the core, engaging the important psoas and core muscles, and support an upright posture, thereby allowing its user to walk with a more natural gait. People who can benefit from using the present system for fitness or recreational walking are not only people with balance or gait issues, or people facing certain or potential knee, hip or back joint correction or replacement surgery, or those whose general ankle, knee, hip, or low back pain, but anyone who is sedentary, deconditioned, and suffering from “sitting disease”. Its stable, rocking bottom with rubber tread promotes a longer, more natural stride with extended elevation. Further, this wider base absorbs more weight and shock and disperses both over a wider area. The result is a stronger, more natural walk.

It is a further object of the instant apparatus to support the body through a series of movements stretching the muscle slings systems and myofascial lines before, during, and after walking.

It is a further object of the instant apparatus to provide the user a light-weight shaft and a shock-absorbing handle assembly ergonomically designed to assist in relieving hand, wrist, arm and shoulder strains. Furthermore, it is designed to increase core, upper body, and lower body strength by the consistent use of all the muscles involved in locomotion.

It is yet another object of the instant apparatus to provide the user a handle that comprises a wide and flat portion to accommodate the spreading of the hand so the fascia in the palm (palmar aponeurosis which is a broad fibrous sheet of connective tissue), can be available to stretch and load.

Since the hand is not in a concentric contraction gripping the handle, it may be possible for the hand receive proprioception information from the compressive nature of the aggressive bike tread. In addition, during the arm swing, when the handle is forward of center over the anterior portion of the rocker, it is easier to swing or loosely toss with just the fingers lightly around the foam handle. With the hand (palm) open and in line with the wrist, there can be a line of pull and tensioning through the palm and arm. Simultaneously as you touch the posterior end of the rocker down and roll forward, the palm comes into contact with the foam handle during the loading phase and the Rocking Stick rolls slightly on the edge tread, mirroring the pronation of the foot as it is loading then heading to toe off. The foot and the hand are synchronized in their mirrored movements and this may allow a much greater load transfer than just from the foot from heel strike to toe-off. The hand and the handle also mirror the bent knee—the straight arm opposite the quadriceps and then the hand/handle joint in flexion (angled forward) and the shaft mirroring the lower leg, the tibialis.

In this respect, it is to be understood that the apparatus is not limited in its application to the details of construction and to the arrangements of the components set forth in the following description or illustrated in the drawings. The apparatus is capable of other embodiments and of being practiced and carried out in various ways. Also, it is to be understood that the phraseology and terminology employed herein are for the purpose of description and should not be regarded as limiting.

These together with other objects of the apparatus, along with the various features of novelty, which characterize the apparatus, are pointed out with particularity in the claims annexed to and forming a part of this disclosure. For a better understanding of the apparatus, its operating advantages and the specific objects attained by its uses, reference should be made to the accompanying drawings and descriptive matter in which there are illustrated preferred embodiments of the apparatus.

### BRIEF DESCRIPTION OF THE DRAWINGS

FIG. 1 illustrates a side view of the apparatus.

FIG. 2 illustrates a front and rear view of the apparatus.

FIG. 3 illustrates an angled view of the apparatus.

FIG. 4 illustrates a top and bottom view of the apparatus.

FIG. 5 illustrates a side view of the handle apparatus.

FIG. 6 illustrates a side view of one embodiment of the handle apparatus.

FIG. 7 illustrates a side view of another embodiment of the handle apparatus.

### DETAILED DESCRIPTION OF THE INVENTION

The detailed description set forth below is intended as a description of presently preferred embodiments of the invention and does not represent the only forms in which the present invention may be construed and/or utilized. The description sets forth the functions and the sequence of the steps for producing the system and accompanying apparatus. However, it is to be understood that the same or equivalent functions and sequences may be accomplished by different embodiments also intended to be encompassed within the scope of the invention.

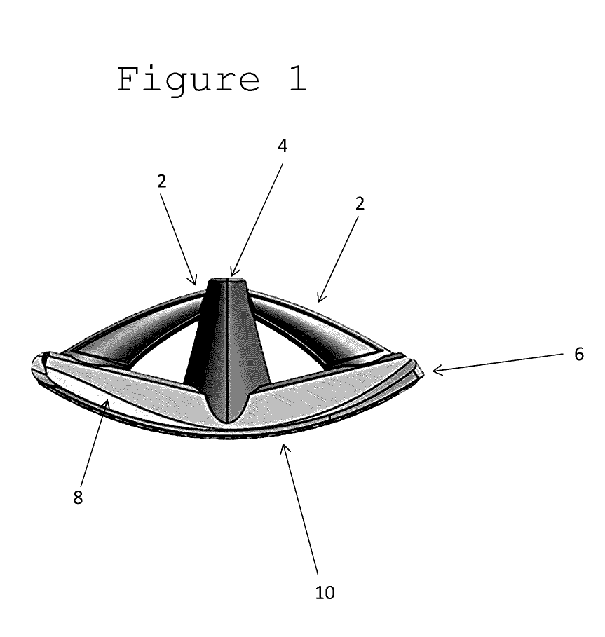

FIG. 1-6 depict various viewpoints of the present system 5 including the rubber tread bottom 10. The present system includes a curved bottom support frame 8, which allows the device to be placed on a surface and support the weight of a user. Attached to the curved bottom support frame 8 is a rubber tread surface 10 and creates friction preventing the system from slipping on the surface. The rubber tread 10 is attached to a curved bottom support frame 8 via a soft shock absorbing material 6 placed between the rubber tread bottom 10 and the curved bottom support frame 8.

This soft shock absorbing material 6 functions to absorb forces being transmitted from a hard surface to the user's hands and wrist, thus reducing the amount of force felt.

FIG. 1 further depicts a central support 4 affixed to the curved or arcuate bottom support frame 8, in which a cane shaft may be attached. The central support 4 acts to provide the main support for the apparatus and is centrally located with respect to the front and back of the apparatus. The central support 4 connects to the curved bottom support frame 8, and the shock absorbing material 6 and the rubber tread 10 are attached to the bottom of central support 4. Furthermore, two support arms 2 are attached to the top of the central support 4 and to the curved bottom support 8 frame distal from the central support 4.

The support arms 2 are used to provide additional support to the apparatus, increasing stability of the apparatus when in operation. As the apparatus is used, the apparatus rocks back and forth so that various points along the rubber tread 10 are in contact with a surface. In one embodiment, the rubber tread 10 is rounded in order to allow the overall assembly to be self-supporting. Further, the rubber tread 10 comprises of a compressible material that may also include a knobbiness texture in order to promote better traction and to mirror pronation during a stance phase.

In operation, as one employs the system, the force of the user travels the shaft and is dispersed through the central support 4, and the support arms 2, allowing the assembly to support the weight of the user without placing excess pressure on individual points of the apparatus. Thus, since there is no true downward push vector, and thus only a rolling forward effect, there really is minimal force on the apparatus.

Thus, where the additional support arms are not necessary, they add to the esthetic value and assist where weight is applied in situation where the user must ascend or descend a hilly terrain.

Furthermore, as the system strikes the ground, the force is transferred from the lower portion of the system, the rubber tread 10, to the shock absorbing material 6, spreading the force vector and allowing the user much greater control.

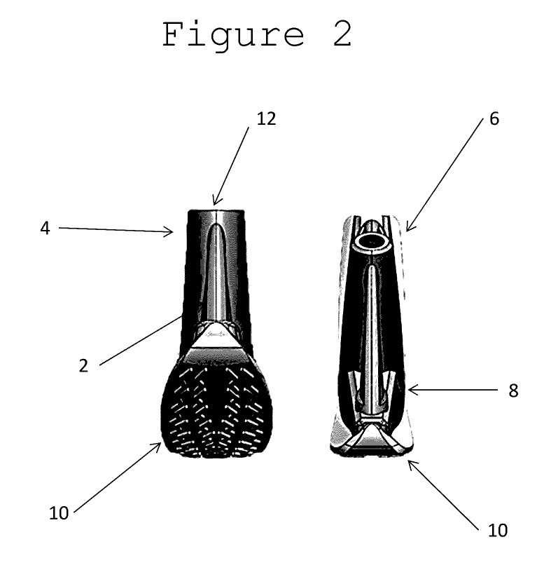

FIG. 2 illustrates the rubber tread 10 extending to cover the front and back of the shock absorbing material 6 and the curved bottom support frame 8. The extension of the rubber tread ensures that the apparatus is able to grip surfaces at various angles to ensure stability.

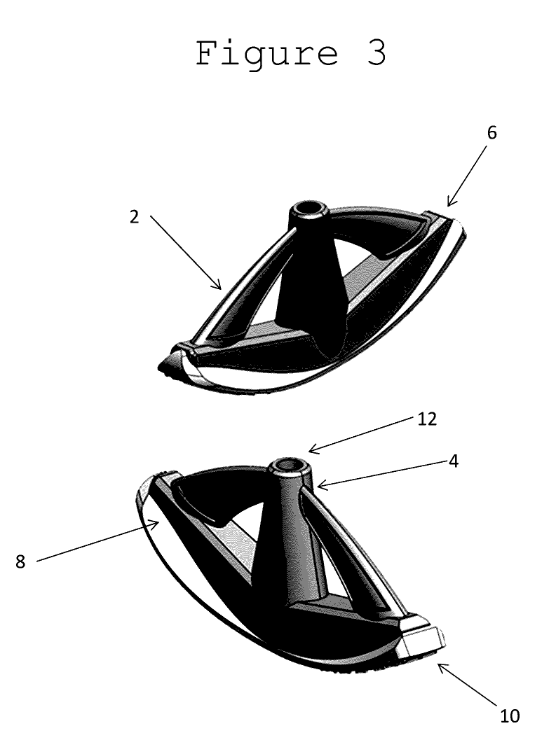

FIG. 3 depicts a side view of the apparatus, in which a hole 12 is present to insert a shaft of a cane. The hole 12 extends to the curved bottom support frame 8, to increase the stability of the apparatus and prevent the cane shaft from bending under the force of the user or coming out of the hole or aperture 12. FIG. 3. also depicts the rubber tread 10 extending around the curved bottom support frame 8.

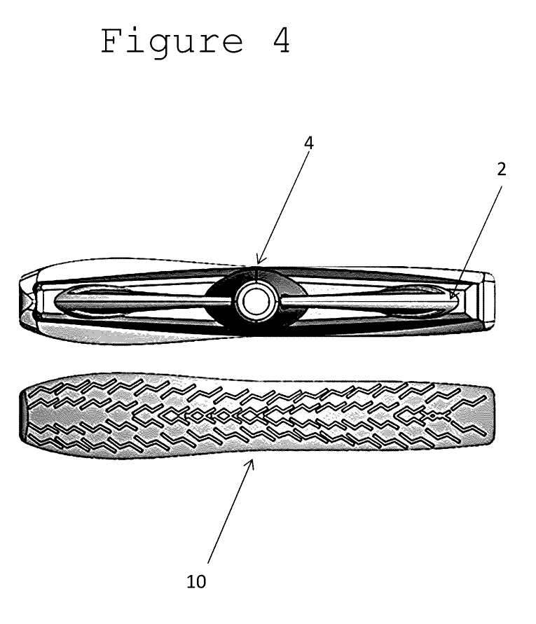

FIG. 4 depicts a top and bottom view of the apparatus. The bottom view depicts the rubber tread 10 attached to the curved bottom support frame 8. The top view depicts the support arms 2, the aperture 12, and the central support 4.

In an alternative embodiment the assembly is attached to a cane shaft, wherein the cane has a specific handle designed to be used with the assembly.

In an alternate embodiment support arms 2, are not present, only a central support 4 and a curved bottom support frame 8 with the shock absorbing material 6 and the rubber tread 10 are present.

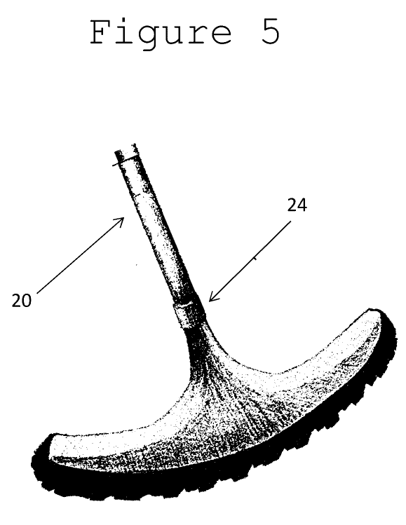

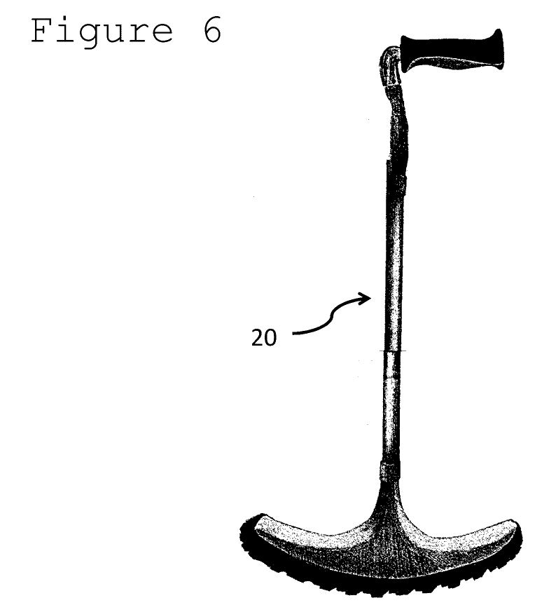

FIGS. 5 and 6 depict a handle assembly 20, which may comprise an aluminum, polymeric, or composite shaft. The shaft may be adjustable to various heights and may comprise locks securely with a metal lock-nut silencer 24. Further, in this embodiment, the system does not require or possess support arms.

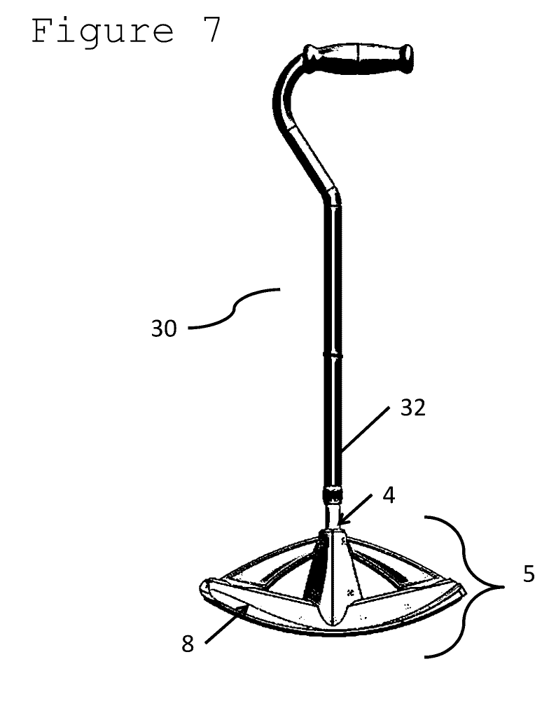

FIG. 7 illustrates yet another embodiment of a handle assembly 30 affixed to the present apparatus 5. The shaft is attached to a central support 4 affixed to the curved or arcuate bottom support frame 8.

In one embodiment, the system comprises a support, exercise and rehabilitation apparatus designed to allow the viscoelastic structure of the myofasciae to resonate in the gravitation field at a frequency that maximizes energy efficiency by mirroring the movements of the foot during a normal gait cycle allowing the body to oscillate in the exact vertical and horizontal sinusoidal waveform necessary.

Additionally, the compression modulus or component of the foot piece tread qualifies as very important and may even aid in some manner by adding some additional compression to hand/arm as it is extended—and thus functions as an additional foot of sorts.

Moreover, the actual curvature of the footpiece, as well as the length vector, may vary as long as the curvature can mirror the natural foot movements during gait. Thus, an optimal curvature and length may be determined by research into the gait of the individual user.

1. A support device comprising:
a shaft member comprising a series of curved areas to form a proper arm angle;
a lower support frame apparatus comprising:
an arcuate support frame
a central support frame;
at least two optional support arms;
a gripping mechanism affixed to the bottom; and,
a coupling mechanism disposed to the lower support frame apparatus to shaft member.

2. The support device of claim 1, wherein the cane is comprised of a shock absorbing material placed between the gripping material and the curved bottom support frame.

3. The support device of claim 1, wherein the gripping material affixed to the bottom is a rubber tread.

4. The support device of claim 1, wherein a shaft is attached to the rocking cane via an insertion hole located on top of the central support.

5. The support device of claim 1, wherein the support arms are affixed to the central support near the insertion hole and to the curved bottom support frame distally located from the central support.

6. The support device of claim 1, wherein an adjustable cane shaft and handle are inserted into the insertion hole.

7. The support device of claim 6, wherein the shaft and handle are made from a material selected from the group consisting of aluminum, wood, or plastic.

8. The support device of claim 6, wherein the handle is angled and curved inwards towards the user.

9. The support device of claim 8, wherein the handle is made of shock absorbing material.

10. The support device of claim 8, wherein the coupling mechanism comprises an adjustment mechanism.

11. The support device of claim 1, wherein the support device is designed to increase core strength and by stretching the iliopsoas muscle, improve posture alignment, and promote the natural, upright walking motion further comprising:
an ergonomically shaped handle; and,
and a rotationally disposed plant, cushioning and release system.

12. A method of rehabilitation of ambulatory skills comprising:
utilizing a support, exercise and rehabilitation apparatus in ambulatory communication with a contact medium;
positioning the shaft handle forward such that the weight is forward the of center of mass in a manner opposite to normal use of a conventional walking device to commence an ambulatory cycle;
actuating the support, exercise and rehabilitation apparatus;
paralleling a heel to toe ankle rocker motion;
mirroring the natural gait of a human with the support, exercise and rehabilitation apparatus;
ensuring that the support, exercise and rehabilitation apparatus remains in constant rotational motion with respect to the contact medium;
lifting the shaft handle forward such that the weight is forward the of center of mass in a manner opposite to normal use of a conventional walking device;
positioning the shaft handle forward such that the weight is forward the of center of mass in a manner opposite to normal use of a conventional walking device to commence an second ambulatory cycle; and,
continuing with consecutive ambulatory cycles as a rehabilitation cycle.

13. (canceled)

14. A support, exercise and rehabilitation apparatus designed to stretch and strengthen the myofascial sling systems used during locomotion by not restricting, limiting or blocking normal joint range of motion and myofascial lines of pull due to absence of downward push on walking cane or aid; comprising:
a. a handle structure comprising:
an upper radial tubular portion; and,
a lower linear tubular portion; and,
b. a rotationally disposed support, landing, cushioning and release system.

15. The support, exercise and rehabilitation apparatus of claim 14, wherein the support, exercise and rehabilitation apparatus is designed to allow the viscoelastic structure of the myofasciae to resonate in the gravitation field at a frequency that maximizes energy efficiency by mirroring the movements of the foot during a normal gait cycle allowing the body to oscillate in the exact vertical and horizontal sinusoidal waveform necessary.

16. The support, exercise and rehabilitation apparatus of claim 15 including a method comprising the steps of:
varying the curvature of the footpiece; and,
varying the length vector of the footpiece to achieve an optimal curvature and length determined by research into the gait of the individual user.

17. The support, exercise and rehabilitation apparatus of claim 16 further comprising the step of varying a compression modulus.

18. (canceled)
